(19) United States
(12) Patent Application Publication
(10) Pub. No.: US 2017/0132121 A1
(43) Pub. Date: May 11, 2017

(54) INCREMENTAL CODE COVERAGE ANALYSIS USING AUTOMATIC BREAKPOINTS

(71) Applicant: International Business Machines Corporation, Armonk, NY (US)

(72) Inventors: Steven Cooper, Ontario (CA); Michael S. Fulton, Ontario (CA)

(73) Assignee: International Business Machines Corporation, Armonk, NY (US)

(21) Appl. No.: 14/934,496

(22) Filed: Nov. 6, 2015

(51) Int. Cl. G06F 11/36

(52) U.S. Cl. CPC G06F 11/3692; G06F 11/3612

(57) ABSTRACT

A portion is selected from a code for code coverage analysis. The portion is not directly referenceable by another portion of the code. An instruction is constructed to insert a code coverage breakpoint at the portion such that the code coverage analysis is performed only for the portion and the code coverage analysis of a remainder of the code is omitted. Using the instruction, a code coverage analysis tool is caused to execute the code without performing the code coverage analysis until the code coverage breakpoint. Responsive to the instruction, the code coverage analysis tool is further caused to end the code coverage analysis after the portion and resume executing the code without performing the code coverage analysis. A report of the code coverage analysis of the portion is produced.

### TECHNICAL FIELD

The present invention relates generally to a method, system, and computer program product for code coverage analysis. More particularly, the present invention relates to a method, system, and computer program product for incremental code coverage analysis using automatic breakpoints.

### BACKGROUND

Code coverage analysis is an analysis of computer code to determine which portions of the code are being executed during an execution. A test case configures an execution of the code such that the circumstances created by the test case cause certain portions of the code to be executed.

Generally, code coverage analysis uses a set of test cases designed to execute various portions of the code. A code coverage analysis tool keeps track of the portions of the code that are actually executed in response to the set of test cases.

It is not uncommon to perform code coverage analysis on code that is thousands of lines in size. It is also not uncommon to have thousands of test cases in a set of test cases for the code coverage analysis of such code.

### SUMMARY

The illustrative embodiments provide a method, system, and computer program product. An embodiment includes a method that selects, using a processor and a memory, from a code, a portion for code coverage analysis, the portion not being directly referenceable by another portion of the code. The embodiment constructs an instruction to insert a code coverage breakpoint at the portion such that the code coverage analysis is performed only for the portion while omitting the code coverage analysis of a remainder of the code. The embodiment causes, using the instruction, a code coverage analysis tool to execute the code without performing the code coverage analysis until the code coverage breakpoint. The embodiment further causes, responsive to the instruction, the code coverage analysis tool to end the code coverage analysis after the portion and resume executing the code without performing the code coverage analysis. The embodiment outputs a report of the code coverage analysis of the portion.

An embodiment includes a computer program product. The computer program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for incremental code coverage analysis using automatic breakpoints in accordance with an illustrative embodiment;

FIG. 4 depicts a block diagram of automatically selecting the fine grained portions of code for code coverage analysis in accordance with an illustrative embodiment; and

FIG. 5 depicts a flowchart of an example process for incremental code coverage analysis using automatic breakpoints in accordance with an illustrative embodiment.

### DETAILED DESCRIPTION

The illustrative embodiments recognize that presently available code coverage analysis tools are only coarsely configurable for code analysis. For example, a presently available code coverage analysis tool allows a user to include or omit a file from a set of files where the set of files together includes the code to be analyzed for coverage. As another example, another presently available code coverage analysis tool allows a user to select or omit an entire class, an entire method, or other similarly referenced named entire portion of a given code for the purposes of analyzing the coverage of that code.

The illustrative embodiments recognize that often, changes made to existing code are incremental such that the changes affect not entire portions of the code but only a line of code or a few lines of code, which can be scattered in different places in the code. The illustrative embodiments recognize that the presently available methods of code coverage analysis are an all-or-nothing proposition, barring the ability to include or exclude entire files or entire named portions in the analysis by some code coverage analysis tools. Even with the ability to exclude files or named portions in their entirety, the presently available code coverage analysis tools are coarse-grained at best in that they are not configurable to specifically include or exclude specific lines of the code that is to be analyzed.

Presently, whether a code line has been executed or not executed during a code coverage analysis exercise can be determined only from performing code coverage analysis on the entire code or at least entire file or entire named portion of the code. A file, a referenceable portion, and/or a named portion of code are collectively referred to hereinafter as a coarse grained portion or a coarse portion. The illustrative embodiments recognize that code coverage analysis is computationally expensive and time consuming. Therefore, the illustrative embodiments recognize that performing code coverage analysis on coarse grained portions of code to determine whether specific lines of code have been covered in an execution is wasteful and expensive.

A line of code is an example of a portion of code that is not directly referenceable by another portion of the code. For example, where a line of code can reference a file (a coarse grained portion) of the code or can call a class (another coarse grained portion), a line of code cannot specifically reference another line of code included within a file or a class. Such a portion that is not directly referenceable by other portions of the code is hereinafter referred to as a fine grained portion or a fine portion.

A code coverage analysis tool uses code coverage breakpoints to identify a coarse portion on which to perform code coverage analysis. The code coverage analysis tool sets a code coverage breakpoint at the beginning of a coarse portion to initiate code coverage analysis responsive to reaching that code coverage breakpoint during the execution of the code. The code coverage analysis tool sets another code coverage breakpoint at the end of the coarse portion to end the code coverage analysis responsive to reaching that that code coverage breakpoint during the execution of the code.

The illustrative embodiments further recognize that manually setting code coverage breakpoints around manually selected portions of the code can be error-prone. For example, to correctly set a code coverage breakpoint manually in a given code, a user who sets the code coverage breakpoint has to be knowledgeable about the operations, functions, and the changes in the code. Such knowledge can be difficult to maintain when the code is developed by one or more teams of developers. Furthermore, even with the knowledge of the code, manually setting code coverage breakpoints is prone to human errors. For example, the user might forget setting a code coverage breakpoint at one of the hundreds of changed portions in the code.

The illustrative embodiments further recognize that presently, given a set of test cases, a code coverage analysis exercise might cover certain existing portions of the code but fail to execute certain lines—or gaps—in the code. Generally, such gaps in the coverage of existing code are fine grained, such as a line of code in hundreds of lines of a coarse portion. It is desirable that when a new test case is designed, such untested existing portions be affirmatively tested. The illustrative embodiments recognize that presently, such gaps cannot be specifically and automatically identified as fine grained portions to a code coverage analysis tool.

The illustrative embodiments further recognize that given a set of test cases, a code coverage analysis exercise might cover certain existing portions of the code. It is possible that a test case that covered an existing fine grained portion was insufficient to execute a portion sufficiently or for some special circumstances. It is desirable that when a new test case is designed, such insufficiently tested existing portions be retested. The illustrative embodiments recognize that presently, such fine grained portions cannot be specifically and automatically identified to a code coverage analysis tool.

The illustrative embodiments further recognize that when an error is corrected in an existing code, a fine grained portion—which includes previously tested lines of code as well as lines changed due to the correction—has to be retested. The retesting may be using an existing test case or a new test case. Presently, such fine grained portions cannot be specifically and automatically identified to a code coverage analysis tool.

The illustrative embodiments used to describe the invention generally address and solve the above-described problems and other problems related to code coverage analysis. The illustrative embodiments provide a method, system, and computer program product for incremental code coverage analysis using automatic breakpoints.

An embodiment can be implemented as a software application. The application implementing an embodiment can be configured as a modification of an existing code coverage analysis tool, as a separate application that operates in conjunction with an existing code coverage analysis tool, a standalone application, or some combination thereof.

A modified code coverage analysis tool according to an embodiment is an existing code coverage analysis tool that has been modified to programmatically accept an instruction to set a code coverage breakpoint at a fine grained portion. Within the scope of the illustrative embodiments, a modified code coverage analysis tool can set a code coverage breakpoint at the beginning of a fine grained portion, at the end of the fine grained portion, or both. Some non-limiting ways for configuring a programmatic interface of the modified code coverage analysis tool, for accepting an instruction to set a code coverage breakpoint, include an application programming interface (API) that can be called with the code coverage breakpoint as a parameter, a command to specify a code coverage breakpoint, and a shared memory in which another application saves a code coverage breakpoint for the modified code coverage analysis tool to read. From this disclosure, those of ordinary skill in the art will be able to conceive many other ways of implementing the programmatic interface of the modified code coverage analysis tool and the same are contemplated within the scope of the illustrative embodiments.

An embodiment is usable to automatically identify a fine grained portion of code that has not been previously tested. The fine grained portion may be a new or changed line of code, an existing line of code not previously tested, or both. The embodiment is further usable to programmatically set a code coverage breakpoint corresponding to the fine grained portion in a modified code coverage analysis tool.

For example, a code library is a tool used for checking out code for editing and checking in the edited code. The code library and other tools are usable to identify the changes in the code from one version to another. For example, a change may be a new line of code inserted in the code. Another example change may be a line of existing code that has been modified. A collection of changes in a version of code is called a changeset.

The embodiment uses a code library or other tool to extract a changeset corresponding to a version of the code for which code coverage analysis has to be performed. The embodiment constructs an instruction to set a code coverage breakpoint relative to a fine grained portion identified in the changeset. The embodiment programmatically supplies the instruction to a modified code coverage analysis tool.

The modified code coverage analysis tool sets the code coverage breakpoint according to the instruction. During the execution of the code, the modified code coverage analysis tool does not break the execution at any point other than the code coverage breakpoint set at the fine portion. The modified code coverage analysis tool outputs a report of code coverage of the fine grained portion.

To identify an existing line of code that has not previously been tested, an embodiment uses historical data of previous code coverage analysis executions. For example, a code coverage analysis of the complete code may have been performed at a previous time. A code coverage analysis report of that execution records the line numbers of the code that were exercised during the code coverage analysis, a test case identifier of the test case that exercised that line of code, or both.

The embodiment compares a historical code coverage analysis report with the code to identify a fine grained section that was not exercised by any test case, by a particular test case, or some combination thereof. The embodiment constructs an instruction to set a code coverage breakpoint relative to a fine grained portion that was not exercised or insufficiently exercised. The embodiment programmatically supplies the instruction to a modified code coverage analysis tool.

The modified code coverage analysis tool sets the code coverage breakpoint according to the instruction. During the execution of the code, the modified code coverage analysis tool does not break the execution at any point other than the code coverage breakpoint set at the fine portion. The modified code coverage analysis tool outputs a report of code coverage of the fine grained portion.

In a similar manner, another embodiment is usable to automatically identify a fine grained portion of code that has been previously tested but should be retested, such as by using a new or a different test case. The embodiment is similarly usable to programmatically set a code coverage breakpoint corresponding to the fine grained portion in a modified code coverage analysis tool.

In a similar manner, another embodiment is usable to automatically identify a combination of fine grained portions of code where the combination includes a line of code that has been previously tested but should be retested and a line of previously untested code, such as responsive to correcting an error in the code. The embodiment is similarly usable to programmatically set a code coverage breakpoint corresponding to the fine grained portions in a modified code coverage analysis tool.

A method of an embodiment described herein, when implemented to execute on a device or data processing system, comprises substantial advancement of the functionality of that device or data processing system in incremental code coverage analysis using automatic breakpoints. For example, presently available code coverage analysis tools allow inclusion or exclusion of only coarse portions of code for code coverage analysis, and manually placing code coverage breakpoints in other places in the code is error-prone. An embodiment provides a method for automatically selecting fine grained portions of code that have to be analyzed for code coverage. An embodiment uses a code library or other comparable tool to generate a changeset of fine grained portions. An embodiment uses a historical code coverage analysis report to identify a fine grained portion that has escaped testing or sufficient testing. An embodiment modifies a code coverage analysis tool to programmatically accept code coverage breakpoint-setting instructions to automatically set and execute code coverage breakpoints at fine grained portions of the code. This manner of incremental code coverage analysis using automatic breakpoints is unavailable in the presently available code coverage analysis tools. Thus, a substantial advancement of such devices or data processing systems by executing a method of an embodiment is in reducing the cost of code coverage analysis, reducing the errors in setting code coverage breakpoints, and reducing the dependency on human knowledge of the code for accurate code coverage analysis.

The illustrative embodiments are described with respect to certain code, files, referenceable portions, coarse portions, fine portions, code coverage analysis tool, code coverage breakpoints, code coverage analysis reports, test cases, changeset identification tools, programmatic access, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments.

Furthermore, a particular illustrative embodiment may have some, all, or none of the advantages listed above.

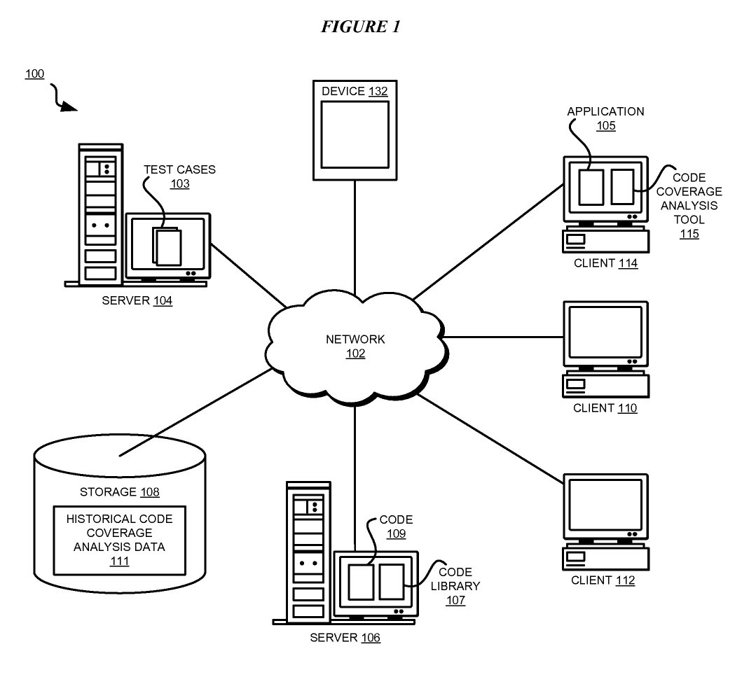

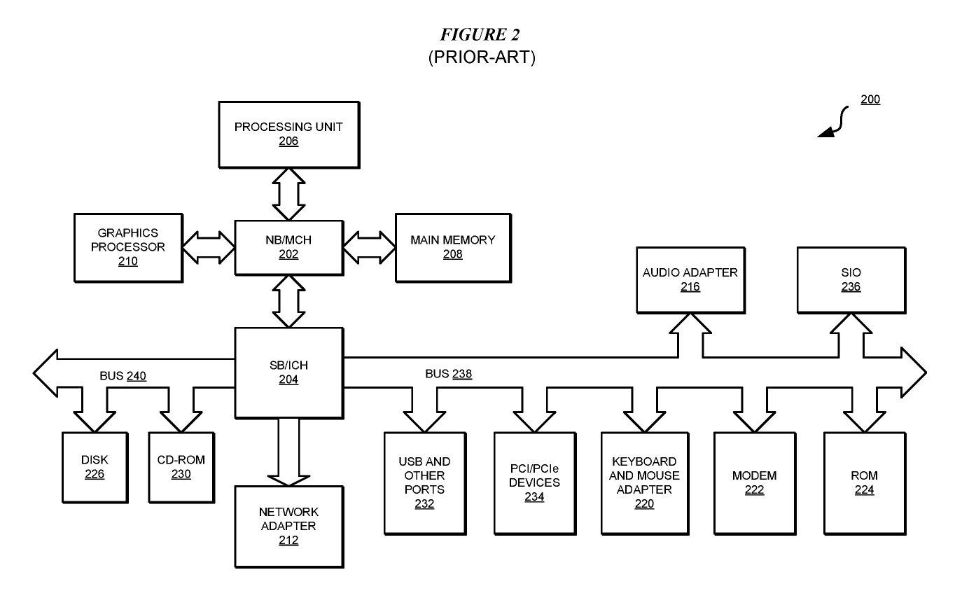

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Code coverage analysis tool 115 is a modified code coverage analysis tool as described herein. Test cases 103 is a set of test cases usable in modified code coverage analysis tool 115 for code coverage analysis of code 109. Code 109 is a non-limiting example of a tool that can provide a changeset relative to code 109. Application 105 uses historical code coverage analysis data 111 to identify a fine grained portion of code 109 that has not been exercised or has been insufficiently exercised by a test case in test cases 103. Application 105 programmatically sets one or more code coverage breakpoints in modified code coverage analysis tool 115 at one or more fine grained portions in code 109.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

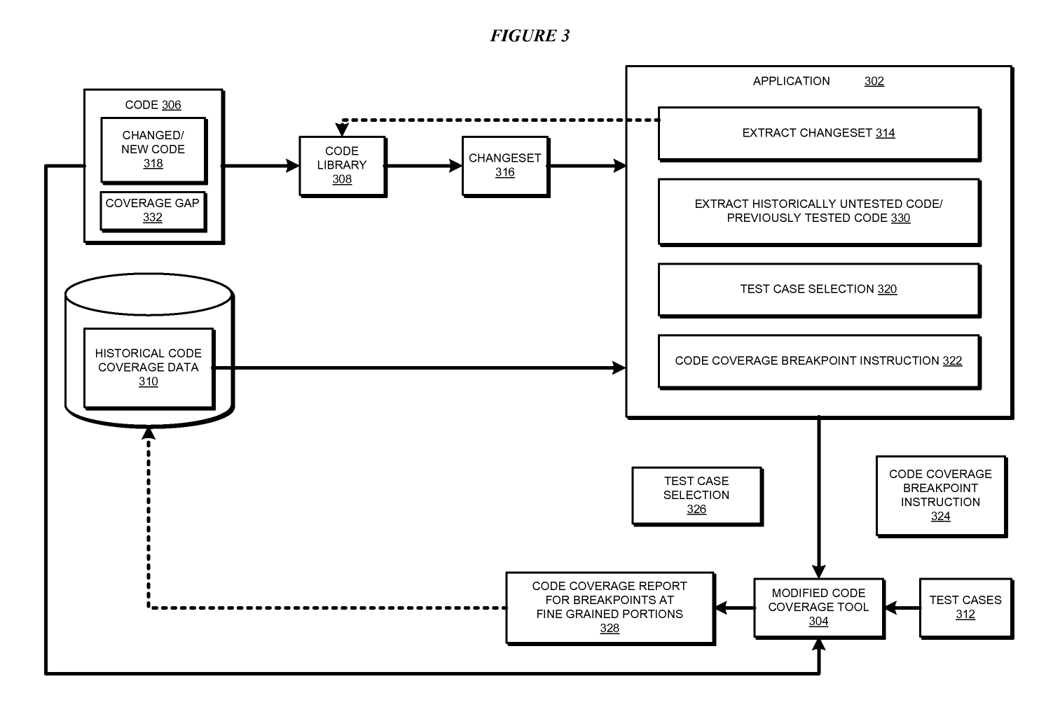

With reference to FIG. 3, this figure depicts a block diagram of an example configuration for incremental code coverage analysis using automatic breakpoints in accordance with an illustrative embodiment. Application 302 is an example of application 105 in FIG. 1. Modified code coverage analysis tool 304 is an example of modified code coverage analysis tool 115 in FIG. 1. Code 306 is an example of code 109 in FIG. 1. Code library 308 is an example of code library 107 in FIG. 1. Historical code coverage analysis data 310 is an example of historical code coverage analysis data 111 in FIG. 1. One or more test cases 312 are examples of test cases 103 in FIG. 1.

Component 314 interacts with code library 308 to extract changeset 316. As an example, assume that changeset 316 identifies changed or new code 318 in code 306. Changed or new code 318 is a fine grained portion in code 306.

Changed or new code 318 may have to be tested using one or more test cases 312. Test case selection component 320 identifies one or more particular test cases from test cases 312 that apply to changeset 316.

Component 322 constructs one or more instructions to set one or more code coverage breakpoints in modified code coverage analysis tool 304, for when code 306 is executed for code coverage analysis. Instruction 324 is an instruction constructed by component 322 to set a code coverage breakpoint at a fine grained portion in code 306, such as at changed or new code 318. If a specific test case has to be executed for code coverage of fine grained portion 318, as selected by component 320, such a selection of test case 326 is also programmatically passed to modified code coverage analysis tool 304.

Modified code coverage analysis tool 304 uses inputs 324 and 326 from application 302, additional test cases 312 if needed in addition to specified test cases 326, and code 306, and performs code coverage analysis on only changed or new code 318. Modified code coverage analysis tool 304 outputs report 328. Report 328 provides the code coverage analysis information relative to the breakpoints set at fine grained portion 318 in code 306. Optionally, report 328 is added to a repository of historical code coverage analysis data, such as the repository providing historical code coverage analysis data 310.

As described herein, in some cases, fine grained portions of existing code may escape code coverage, creating gaps in code coverage. To test the fine grained portions corresponding to such gaps, a new test case may be constructed.

Component 330 uses historical code coverage analysis data 310 to identify a gap in a previous code coverage analysis of code 306. For example, using the information from historical data 310 about the portions of code 306 covered in the previous code coverage analysis, component 330 identifies that a code coverage gap exists at fine grained portion 332 in code 306.

Component 320 selects a new test case that is created for analyzing the fine grained portion 332. The new test case forms selected test case 326. Component 322 constructs an instruction to set a code coverage breakpoint at fine grained portion 332. The instructions forms instruction 324.

Modified code coverage analysis tool 304 uses inputs 324 and 326 to perform code coverage analysis of only fine grained portion 332. Modified code coverage analysis tool 304 outputs report 328. Report 328 provides the code coverage analysis information relative to the breakpoints set at fine grained portion 332 in code 306. Optionally, report 328 is added to the repository of historical code coverage analysis data, such as the repository providing historical code coverage analysis data 310.

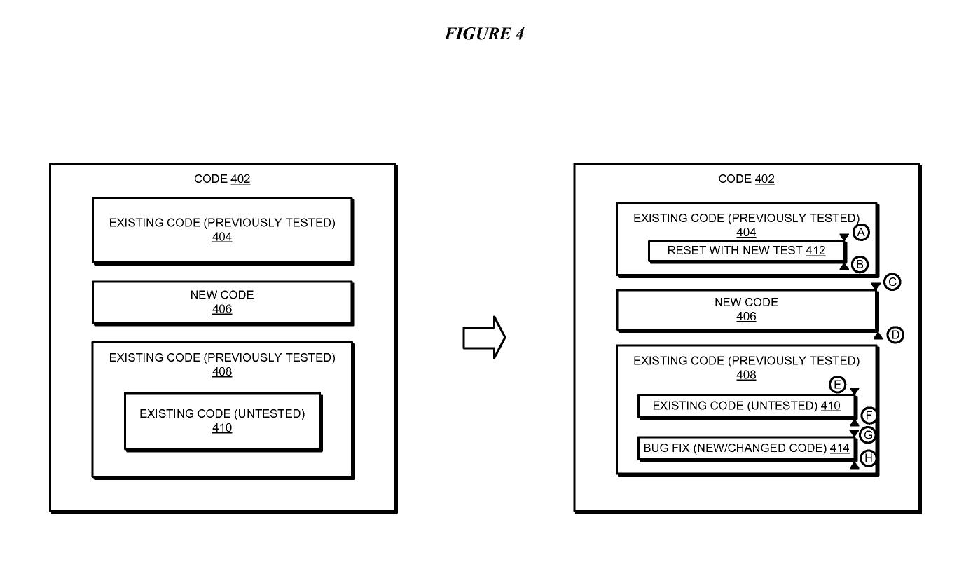

With reference to FIG. 4, this figure depicts a block diagram of automatically selecting the fine grained portions of code for code coverage analysis in accordance with an illustrative embodiment. Code 402 is an example of code 306 in FIG. 3.

Suppose that coarse portion 404 has been previously tested with a test case for code coverage. Fine grained portion 406 is a new one or more line of code that has been added to code 402. Coarse grained portion 408 has also been previously tested with a test case for code coverage. Fine grained portion 410 within coarse grained portion 408 is existing code that corresponds to a gap in the code coverage of coarse grained portion 408.

An embodiment, such as in application 302 in FIG. 3, identifies fine grained portion 412 in coarse grained portion 404. Assume that fine grained portion was tested with the test case that tested coarse grained portion 404 but has to be retested with a new test case. Accordingly, the embodiment sets, or causes to be set, code coverage breakpoint A at the beginning and code coverage breakpoint B at the end of fine grained portion 412. The embodiment selects a new test case to test fine grained portion 412.

Only as a non-limiting example, in the depiction of FIG. 4, a fine grained portion is depicted bound by a code coverage breakpoint at the beginning of the fine grained portion and a code coverage breakpoint at the end of the fine grained portion. From this disclosure, those of ordinary skill in the art will be able to conceive many other ways of setting code coverage breakpoints relative to fine grained portions and the same are contemplated within the scope of the illustrative embodiments.

Because fine grained portion 406 is new code, an embodiment sets, or causes to be set, code coverage breakpoint C at the beginning and code coverage breakpoint D at the end of fine grained portion 406. Similarly, because fine grained portion 410 represents a gap in the previous code coverage analysis, an embodiment sets, or causes to be set, code coverage breakpoint E at the beginning and code coverage breakpoint F at the end of fine grained portion 410.

A modified code coverage analysis tool, such as modified code coverage analysis tool 304 in FIG. 3, performs code coverage analysis for only fine grained portion 412, 406, and 410 using code coverage breakpoints A, B, C, D, E, and F. The remainder of code 406 is executed normally without breaking the execution for code coverage analysis.

Now, suppose that the new test case used to test fine grained portion 412 reveals a bug in code 402. A developer addresses the bug by applying a bug fix in code 406. Assume that the bug fix adds or changes fine grained portion 414 of code 406. Because fine grained portion 414 is new or changed code, an embodiment sets, or causes to be set, code coverage breakpoint G at the beginning and code coverage breakpoint H at the end of fine grained portion 406.

Assume that the bug is identified in one iteration of code coverage analysis and the bug fix is analyzed in another iteration of code coverage analysis. A modified code coverage analysis tool, such as modified code coverage analysis tool 304 in FIG. 3, performs code coverage analysis for only fine grained portion 414 using code coverage breakpoint G and H. The remainder of code 406—including fine grained portion 412, 406, and 410, which are have been tested in the previous iteration of code coverage analysis—is executed normally without breaking the execution for code coverage analysis. If the bug is identified in a separate debug session, and bug fix is applied before a code coverage analysis is performed, the modified code coverage analysis tool performs code coverage analysis for fine grained portion 412, 406, 410, and 414 using code coverage breakpoints a, B, C, D, E, F, G and H.

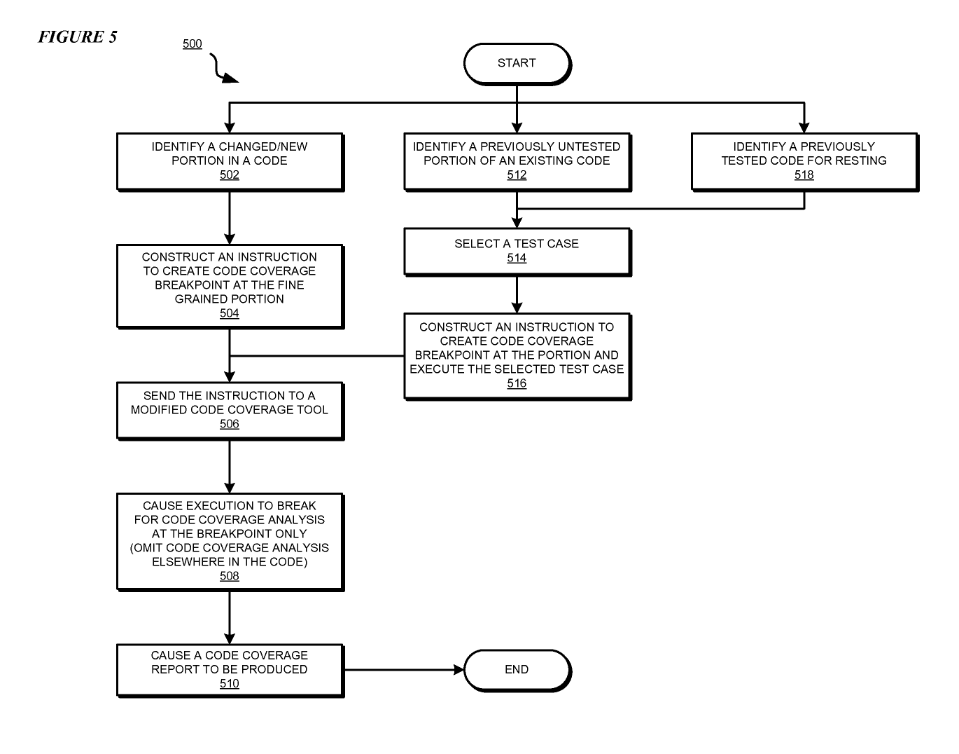

With reference to FIG. 5, this figure depicts a flowchart of an example process for incremental code coverage analysis using automatic breakpoints in accordance with an illustrative embodiment. Process 500 can be implemented in application 302 in FIG. 3.

The application can follow one of three possible paths in process 500. According to a first path that initiates at block 502, the application identifies new or changed code, such as in a changeset (block 502). The application constructs an instruction to create a code coverage breakpoint at the fine grained portion corresponding to the new or changed code (block 504). The application sends the instruction to a modified code coverage analysis tool to set the code coverage breakpoint at the fine grained portion (block 506). The application causes an execution of the code to break for code coverage analysis only at the code coverage breakpoint set at the fine grained portion, omitting code coverage analysis in other parts of the code (block 508). The application causes a code coverage analysis report to be produced for the fine grained portion (block 510). The application ends process 500 thereafter.

According to a second path that initiates at block 512, the application identifies previously untested existing fine grained portion in a given code (block 512). The application selects a test case, such as a new test case, to test the previously untested fine grained portion (block 514). The application constructs an instruction to create a code coverage breakpoint at the existing untested fine grained portion and to use the new test case to perform code coverage analysis at the untested fine grained portion (block 516). The application proceeds to block 506 and proceeds thereafter as described in the first path.

According to a third path that initiates at block 518, the application identifies previously tested existing fine grained portion for retesting, such as using a new test case (block 518). The application proceeds to block 514 and proceeds thereafter as described in the first and second paths.

Thus, a computer implemented method, system or apparatus, and computer program product are provided in the illustrative embodiments for incremental code coverage analysis using automatic breakpoints. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to the consumer by executing the application on a cloud infrastructure. The application is accessible from various client devices through a thin client interface such as a web browser (e.g., web-based e-mail). The user does not manage or control the underlying cloud infrastructure including network, servers, operating systems, storage, or even the capabilities of the application, with the possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
selecting, using a processor and a memory, from a code, a portion for code coverage analysis, the portion being a single line of the code such that the single line of the code is not directly referenceable by another line of the code;
constructing an instruction to insert a code coverage breakpoint at the portion such that the code coverage analysis is performed only for the portion while omitting the code coverage analysis of a remainder of the code;
causing, using the instruction, a code coverage analysis tool to execute the code without performing the code coverage analysis until the code coverage breakpoint;
further causing, responsive to the instruction, the code coverage analysis tool to end the code coverage analysis after the portion and resume executing the code without performing the code coverage analysis; and
outputting a report of the code coverage analysis of the portion.

2. The method of claim 1, further comprising:
selecting a test case, wherein the test case is applicable to the portion; and
including, in the instruction, an indication to use the test case to perform the code coverage analysis.

3. The method of claim 1, wherein the instruction causes the code coverage breakpoint to be inserted at a beginning of the portion, wherein the code coverage breakpoint causes an initiation of the code coverage analysis.

4. The method of claim 3, wherein the instruction further causes a second code coverage breakpoint to be inserted at an end of the portion, wherein the second code coverage breakpoint causes an end of the code coverage analysis.

5. The method of claim 1, further comprising:
invoking a code change management tool to identify a changeset corresponding to the code, the changeset including the portion.

6. The method of claim 5, wherein the portion comprises new code and wherein the new code has not been previously tested for code coverage analysis.

7. The method of claim 5, wherein the portion comprises a changed form of an existing portion, wherein the changed form has not been previously tested for code coverage analysis.

8. The method of claim 1, further comprising:
accessing a historical data of a previous code coverage analysis of the code; and
identifying, from the historical data, a gap in the previous code coverage analysis, wherein the gap corresponds to the portion, and wherein the portion comprises existing code that is unchanged since the previous code coverage analysis.

9. The method of claim 1, further comprising:
identifying the portion such that the single line of the code in the portion has not been previously tested for code coverage analysis;
identifying a second portion, the second portion being a second single line of the code, the second single line of the code is not directly referenceable by another line of the code, and wherein the second single line of the code in the second portion has been previously tested for code coverage analysis;
configuring, as a part of the constructing, the instruction to insert the code coverage breakpoint at the single line of the code of the portion and insert a second code coverage breakpoint at the second single line of the code of the second portion.

10. The method of claim 9, wherein the second single line of the code has been previously tested using a first test case, further comprising:
causing the second single line of the code to be retested using a second test case.

11. A computer program product comprising one or more computer-readable storage devices, and program instructions stored on at least one of the one or more storage devices, the stored program instructions comprising:
program instructions to select, using a processor and a memory, from a code, a portion for code coverage analysis, the portion being a single line of the code such that the single line of the code is not directly referenceable by another line of the code;
program instructions to construct an instruction to insert a code coverage breakpoint at the portion such that the code coverage analysis is performed only for the portion while omitting the code coverage analysis of a remainder of the code;
program instructions to cause, using the instruction, a code coverage analysis tool to execute the code without performing the code coverage analysis until the code coverage breakpoint;
program instructions to further cause, responsive to the instruction, the code coverage analysis tool to end the code coverage analysis after the portion and resume executing the code without performing the code coverage analysis; and
program instructions to output a report of the code coverage analysis of the portion.

12. The computer program product of claim 11, the stored program instructions further comprising:
program instructions to select a test case, wherein the test case is applicable to the portion; and
program instructions to include, in the instruction, an indication to use the test case to perform the code coverage analysis.

13. The computer program product of claim 11, wherein the instruction causes the code coverage breakpoint to be inserted at a beginning of the portion, wherein the code coverage breakpoint causes an initiation of the code coverage analysis.

14. The computer program product of claim 13, wherein the instruction further causes a second code coverage breakpoint to be inserted at an end of the portion, wherein the second code coverage breakpoint causes an end of the code coverage analysis.

15. The computer program product of claim 11, the stored program instructions further comprising:
program instructions to invoke a code change management tool to identify a changeset corresponding to the code, the changeset including the portion.

16. The computer program product of claim 15, wherein the portion comprises new code and wherein the new code has not been previously tested for code coverage analysis.

17. The computer program product of claim 15, wherein the portion comprises a changed form of an existing portion, wherein the changed form has not been previously tested for code coverage analysis.

18. The computer program product of claim 11, the stored program instructions further comprising:
program instructions to access a historical data of a previous code coverage analysis of the code; and
program instructions to identify, from the historical data, a gap in the previous code coverage analysis, wherein the gap corresponds to the portion, and wherein the portion comprises existing code that is unchanged since the previous code coverage analysis.

19. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to select from a code, a portion for code coverage analysis, the portion being a single line of the code such that the single line of the code is not directly referenceable by another line of the code;
program instructions to construct an instruction to insert a code coverage breakpoint at the portion such that the code coverage analysis is performed only for the portion while omitting the code coverage analysis of a remainder of the code;
program instructions to cause, using the instruction, a code coverage analysis tool to execute the code without performing the code coverage analysis until the code coverage breakpoint;
program instructions to further cause, responsive to the instruction, the code coverage analysis tool to end the code coverage analysis after the portion and resume executing the code without performing the code coverage analysis; and
program instructions to output a report of the code coverage analysis of the portion.

20. The computer system of claim 19, the stored program instructions further comprising:
program instructions to select a test case, wherein the test case is applicable to the portion; and
program instructions to include, in the instruction, an indication to use the test case to perform the code coverage analysis.
